(19) United States
(12) Patent Application Publication
(10) Pub. No.: US 2018/0096109 A1
(43) Pub. Date: Apr. 5, 2018

(54) System and Method for Data Tracking Within a Network of Devices

(71) Applicant: Under Armour, Inc., Baltimore, MD (US)

(72) Inventors: Ben Hamill, Austin, TX (US); Allan Glen, Denver, CO (US); Bradford J. Fults, Austin, TX (US); Andrew Harrison, Austin, TX (US); James Crasta, Denver, CO (US); Eric Roberts, Austin, TX (US); Christopher Peters, Austin, TX (US)

(21) Appl. No.: 15/658,512

(22) Filed: Jul. 25, 2017

Related U.S. Application Data
(60) Provisional application No. 62/403,882, filed on Oct. 4, 2016.

(51) Int. Cl. G06F 19/00; G06F 17/30

(52) U.S. Cl. CPC G06F 19/3418; G06F 19/322; G06F 17/30005

(57) ABSTRACT

System and method for data tracking. In one embodiment, a method of tracing at least one health-related data record representative of at least one health-related parameter of at least one user thereof within a network of devices is given. The method comprises receiving, at a network apparatus, the at least one health-related data record generated at a health monitoring device; generating first metadata comprising at least information identifying the health-monitoring device and the at least one user; providing the at least one health-related data record to an apparatus configured to perform a transformational operation thereon to generate at least one transformed data record; and generating second metadata comprising at least information identifying the apparatus and the transformational operation which was performed. The first and second metadata are stored as a single metadata file relating to the at least one transformed data record.

### PRIORITY AND RELATED APPLICATIONS

The present application claims priority to U.S. Provisional Patent Application Ser. No. 62/403,882 of the same title, filed on Oct. 4, 2016, which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD

This disclosure relates generally to the field of data tracking within a network of devices. More particularly, the present disclosure relates to systems, computer programs, devices, and methods for tracking a path which health-related data has travelled within a network of devices each configured to perform at least one producing, processing or transforming step thereon; the tracking including identification of a data origin, as well as an identifier of each device and a processing/transformation step performed thereby.

### BACKGROUND

In recent years, health monitoring devices that are used or worn by users to measure or track physical and physiological information relating to the health and activity levels of the users have gained great popularity. Such health monitoring devices collect health data relating to a user, and enable the data to be stored, processed, and displayed to the user. In one embodiment, the health monitoring devices comprise computing devices, such as smartphones or personal computers, which are configured to execute one or more software programs for analysis of the data. Common health data analysis systems provide displays of historical health information for the user. Additionally, analysis systems may provide information relating to the user's health goals, diet advice or analysis, and exercise advice or analysis, etc. based on the collected health data. Additionally, some users have more than one health monitoring device. For example, a user may carry a smartphone throughout the day that acts as a pedometer to record steps or general activity levels: additionally the user may wear a wristband with a larger array of sensors and/or different types of sensors during workouts and/or use sensor enabled equipment.

Given the rapid advances in the field of health monitoring, many users upgrade to newer health monitoring devices over comparatively short time periods. Existing analysis systems, however, have difficulties in processing health data from multiple devices for a single user. Combining data from different hardware devices often produces inaccurate analytical results or the analysis system must discard historical health data to process only health data from a new device. Moreover, in certain instances it is advantageous to know an identity of a device which collected data as well as each of the processing steps the data has traversed and the devices which processed the data. Consequently, improvements to analysis systems to improve analysis of health data for a user from multiple health monitoring devices are needed.

Moreover, as various different types of health parameter monitoring devices enter the market and as users utilize several health monitoring devices, enhanced storage solutions for storing data-over-time are needed. Ideally, such solutions would enable comparison and/or deduplication of the data.

### SUMMARY

The present disclosure addresses the foregoing needs by disclosing, inter alia, methods, devices, systems, and computer programs for: (i) tracking data within a network of devices--beginning with one or more origination devices and through to one or more transformational steps; and (ii) enabling a continuous stream data timeline to be created and stored.

Specifically, methods, apparatus, computer applications, and systems are provided to enable health data from one or more health monitoring devices associated with a user to be tracked or traced throughout a series of processing steps irrespective of a device which performs the processing step. In one embodiment, the tracking or tracing is accomplished by generating a unique metadata file as the data is collected and processed. The identifying metadata identifies a device which created the data. Thereafter, additional metadata is added relating to each data processing step performed and the device which performed the step.

These and other aspects of the disclosure shall become apparent when considered in light of the disclosure provided herein.

### BRIEF DESCRIPTION OF THE DRAWINGS

FIG. 1 is a block diagram illustrating an exemplary system for tracking data within a network of devices.

FIG. 1A is a block diagram illustrating an exemplary data path configuration.

FIG. 2 is a logical flow diagram illustrating an exemplary method for tracking data within a network of devices.

FIG. 3 is an exemplary data flow demonstrating generation of a metadata file for tracking data within a network of devices.

FIG. 4A is a logical flow diagram illustrating an exemplary method for obtaining data relating to all health parameters recorded using a specific health monitoring device.

FIG. 4B is a logical flow diagram illustrating an exemplary method for appending data to an existing data path.

FIG. 4C is a logical flow diagram illustrating an exemplary method for obtaining a data path identifier.

FIG. 4D is a logical flow diagram illustrating an exemplary method for sending new data to be persisted.

FIG. 4E is a logical flow diagram illustrating an exemplary method for determining whether a component is included in a data path.

FIG. 5 is a block diagram illustrating an exemplary decoupled timeline data flow in accordance with one embodiment of the present disclosure.

All Figures © Under Armour, Inc. 2017. All rights reserved.

### DETAILED DESCRIPTION

Disclosed embodiments include systems, apparatus, methods and storage media associated with data tracking in general, and in particular creating descriptive metadata which identifies each processing step performed and a device which performed the step. Additionally, means for centralized storage of continuous stream data are provided.

In the following detailed description, reference is made to the accompanying drawings which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C). Similar logic applies to the use of the term “or” herein; i.e., “A or B” means (A), (B), or (A and B).

The terms “comprising,” “including,” “having,” and the like, as used with respect to embodiments of the present disclosure, are synonymous.

### Network Architecture

As noted above, there exists a persistent need to know where a piece of data has been on its way to being persisted within an information storage network, such as that used for the storage of health-related parameter data. It is advantageous to maintain metadata associated to collected data regarding the device from which it originated; the specific sensor used by that particular device to record the data; the software application which pulled the data from the particular device; the operating system (OS) and model of device (e.g., phone model) on which the application was run; the pre- and/or post-processing has been done to the data; etc. In order to track the foregoing features, more than a single point-of-origin data point type of metadata is needed. Rather, what is needed is a means to track the entire chain of custody for anything that has meaningfully touched the piece of data on its path to wherever it gets stored. As used herein, the term “data path” is intended to refer to this chain of custody.

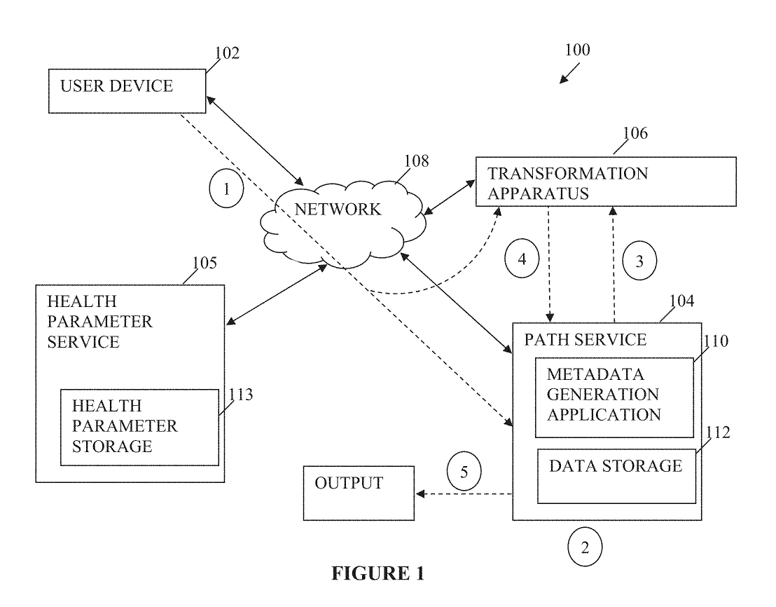

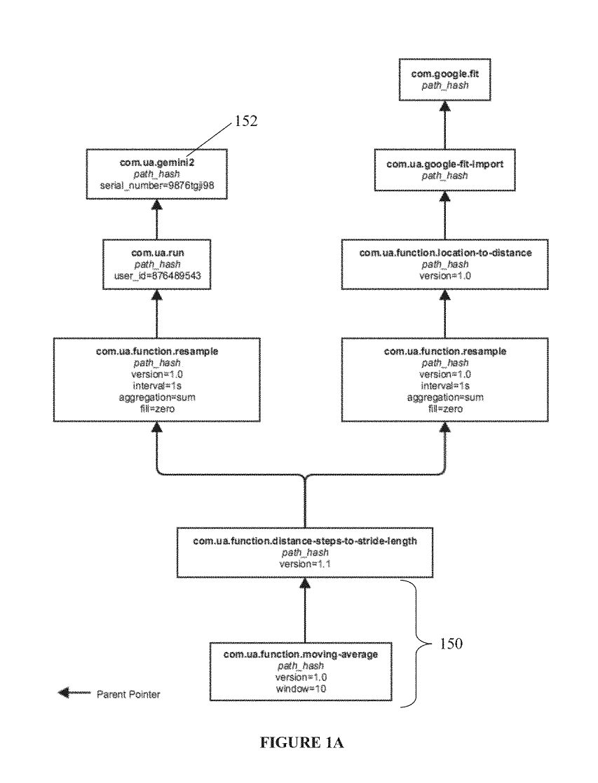

Referring now to FIG. 1, an exemplary system for tracking data within a network of devices is shown. As illustrated, the system generally comprises one or more user devices 102 in communication with one or more path servers 104, one or more health parameter servers 105, and one or more transformation apparatus 106 via a network 108. It is noted that in FIG. 1, the solid lines represent actual connections (whether wired or wireless), and the dotted lines represent logical connections.

The network 108 which enables communication between the plurality of user devices 102, the plurality of transformation apparatus 106, and the path server 104 (each discussed in turn below) may comprise one or more wired and/or wireless, private and/or public network, including but not limited to, e.g., the Internet. The network 108 is, for example, a wireless local area network (WLAN), wireless wide area network (WWAN), wired network, or any other suitable communication channel. Accordingly, each of the user devices 102, path servers 104, and transformation apparatus 106 are configured with appropriate networking communication interfaces. An example of wired communication interface may include, but is not limited to, Ethernet; while examples of wireless communication interfaces may include, but are not limited to, near field communication (NFC), Bluetooth, WiFi, 4G or 5G LTE. It is further appreciated that various gateways, routers, switches, base stations, and so forth may be involved in facilitating and forwarding communication between the foregoing devices. Additionally, it is noted that the foregoing network may comprise several networks, such that the described components are distributed in various ones thereof. In alternative embodiments, the network may comprise a series of devices communicating within software via software API's.

The user devices 102, in one exemplary implementation, comprise one or more portable computerized devices which are configured to measure, obtain, monitor, generate, collect, sense, or otherwise receive biometric, environmental, activity and/or health parameters. User devices 102 may also be referred to herein as health and/or activity monitoring devices. In one variant, certain ones of the user devices 102 comprise wearable health-related parameter measurement and computing devices, such as e.g., a smart watch, an activity tracker, a heart rate monitor, a sleep tracking device, a nutrition tracking device, a smart scale, and/or smart eyeglasses. In addition, an exemplary user device 102 may comprise a smartphone having one or more of the foregoing capabilities and/or which enables user entry of the foregoing health data.

The sensed health parameter data comprises data which the particular device 102 is configured to collect (such as activity, biometric, and environmental data). For example, an activity tracking device is configured to collect activity data such as steps taken, distance travelled, rate or pace of a run, and/or flights of stairs climbed, etc.; a heart rate monitor is configured to collect heartbeat data; a sleep tracking device collects data relating to how much time a user/wearer spends sleeping; a nutrition tracking device collects data relating to food and drinks consumed by a user; a smart scale collects data relating to a body weight, body fat percentage, and/or body mass index (BMI), etc. Furthermore, a smartwatch and/or smartphone, may be utilized as an activity tracking device, a heart rate monitor, a sleep tracking device, and/or a nutrition tracking device. The user device 102 may comprise any of the foregoing types of devices and/or may receive collected data from a first device at one or more applications running on the user device 102.

In certain embodiments, a single user may be associated to multiple user devices 102. For example, a particular user may employ a wrist worn device for capturing activity data, a smart scale for measuring body weight and body fat percentage, a smartphone application for entering nutrition data, and a chest strap for capturing heart rate. Each device is given a unique device identifier (“device ID”); similarly, each user is given a unique user identifier (“user ID”). In this manner, health parameter data that is obtained, generated, collected, sensed, or otherwise received at each user device 102 and relating to a particular user is appropriately distinguishable or identifiable.

The exemplary user device 102 may be further configured to run one or more applications configured to process collected data. Exemplary applications include e.g., UA Record™, MapMyFitness®, MyFitnessPal®, Endomondo®, etc. each owned by assignee hereof. Other health activity related monitoring applications may additionally be utilized in connection with the present disclosure, such as those specifically designed to receive information from a particular type of health monitoring device (i.e., an application which is published by the device manufacturer); the foregoing being merely representative of the general concepts of the present disclosure.

The path service 104 as illustrated in FIG. 1 comprises one or more computerized devices operable to receive data from e.g., the user devices 102 and/or the transformation apparatus 106 for tagging and storage. As shown, the exemplary path service 104 comprises at least a metadata generation application 110 and data storage 112.

The data path service 104 is configured to map identifiers to data paths for other services to store alongside data (such as via the metadata generation application 110). It will also house functionality for fulfilling some queries for data sets, tracking the identity of components (each component is a step in the data path) and storing metadata about components for each data path. In one embodiment, the client-side interface (not shown) to the path service 104 surface area is very small, focusing on answering questions that users have in real-time. Questions for debugging and/or analytics are, in this embodiment, relegated to asynchronous interactions and some may be handled by services which are entirely separate from the path service 104.

The metadata generation application 110, in one embodiment, comprises computer executable instructions which are configured to cause the path service 104 to perform the functions discussed above, including e.g., generating metadata tags to be associated to data. The metadata describes the sequence, generation, processing, combination, and/or transformation of the data. For example, the metadata tags may identify the user (such as by user ID), the device (such as by device ID), and an action or process taken with respect to the data. In one embodiment, the descriptive metadata or data path is attached to the data itself such that as data is passed from one device or process to another, so too is its associated metadata/data path passed. In another alternative, the metadata or data path is stored separately from the data itself and the data comprises a unique identifier which points to a particular location in storage 112 where the data path/metadata may be found.

The action or process (also referred to as: transformation, operation, and/or procedure) refers to any process that receives the health parameter data and generates a modified or “transformed” set of health parameter data output. Using a data path it is advantageously possible to trace a data output through the multiple transformations which have been applied thereto as discussed elsewhere herein.

The processes are performed by one or more transformation apparatus 106. In one embodiment, one or more user devices 102 may operate as transformation apparatus 106 in that they may be configured to run one or more applications thereon which transform the health parameter data. For example, an app running on a user's smartphone (i.e., user device 102) may be configured to transform heart rate data into an intensity score, may be configured to turn GPS location data into distance, and/or may be configured to turn elevation data into slope. Other transformation apparatus 106 may comprise non-user device entities which implement one or more transformation processes.

As discussed, the metadata generation or path generation application 110 is configured to enable a user to ask about data paths as well as create new data paths. To this end, the data path service 104 is configured to issue identifiers for new data paths, describe the data path that belongs to a particular identifier, and list identifiers for data paths that match a query. In one embodiment, the service does not differentiate between individual athletes or users (from or about whom data is collected), per se, but it does differentiate individual devices from one another. In this manner, many data paths may practically belong to a specific user.

As noted above, the data path service 104 also maintains a client library (such as at data storage 112) that enables client developers to efficiently obtain information relating to a data path. In one embodiment, a plurality of client libraries are utilized, such as one for each operating system from which data may be obtained (e.g., one for iOS™ and one for Android®). In the instance that a user is simply putting data into the infrastructure, the library is configured to substantially assemble the correct data path for them.

As noted above, each step in the data path is referred to herein as a “component”. In one embodiment, component is a uniform resource identifier (URI) that encodes a manufacturer or maker and a product (e.g. com.ua.record, com.acme.health-kit). According to this embodiment, the data path service 104 may prescribe the specific component URIs it is configured to accept in a component registry. Additional component URI's may be manually entered to the registry based on e.g., frequency of use. In one variant, the component registry comprises a MySQL® table having a single column that is used as a so-called whitelist. In another embodiment, alternative means for uniquely identifying each component may be used, such as UUID, etc.; the foregoing example is merely demonstrative of the overall concept.

It is appreciated that in the examples discussed herein, the foregoing data path service 104 provides the herein disclosed tagging via API over the network 108. In another variant, however, the path service including a metadata generation application are provided at the user device 102. According to this variant, the user device 102 is configured to generate and apply metadata tags to sensed or obtained health-related data without input or reference to any network apparatus.

The data storage 112 comprises one or more standard database entities which are configured to store data sent thereto. The data storage 112 includes both volatile random access memory (RAM) and a non-transitory memory device such as NAND flash or another form of solid-state memory storage device. In another embodiment, the data storage entities 112 are provided as separate entities from the path service 104 yet in communication therewith via the network 108.

In one variant, it is noted that that there is data of interest relating to the collected health-parameter data which it would be advantageous to track and which would not be appropriate to force creation of an entirely new data path (e.g. the version of an app or OS of the phone it's running on). However, storing this same data in the path itself is cumbersome and inefficient. Therefore, according to this variant, certain data is stored in a separate-but-related store within the service 104 (i.e., separate storage than the path storage 112 discussed above, yet associated thereto). According to this approach, additional data or information types may be easily tracked; i.e., the storage mechanism is designed to be expandable or scalable with the different types of data about which information is later desired. In a further embodiment, a mechanism is provided to account for changes to metadata over time, e.g., path_hash, attribute_name, attribute_value, timestamp. The service 104 therefore enables retrieving and setting this information for a data path.

The structure of a data path in one embodiment comprises a set of linked nodes that describe where a piece of data started and all the steps it went through to get to its eventual resting place. These structures can be branching, for example in a case where two pieces of data recorded by different sensors are used to calculate a third piece of data. An exemplary data path structure is shown in FIG. 1A.

As illustrated in FIG. 1A, the exemplary data path is made up of a series of steps 150. Each step 150 contains identifying information and points to its parent(s). As noted above, each step 150 points at its parent(s), and in one example, some steps 150 have more than one parent. Parent pointers can be thought of as pointing backwards in time. So the “front” of a data path is the most recent event. Given that each step encodes parent information, as shown, it therefore also contains the whole path.

A component 152 comprises a single piece of information, i.e., a URI that encodes an organizational owner and a device, object, or function. Some examples include: com.ua.record; com.acme.fitness-band; com.ua.function.willpower. As noted above, each step 150 comprises a plurality of information which universally identifies the step 150 (and the whole data path to that point in time). In one embodiment, the information comprises a component URI (e.g. com.ua.record), one or more tags (e.g. serial_number=9876rfbnro1 or user_id=8987654), one or more parent pointers (path hashes that identify 0-to-n data paths that precede this one in time), a step hash (a hash of component URI+tags), and a path hash (a hash of component URI+tags+parent pointers; this is what other systems will treat as the data path identifier in one variant).

As noted above, the path hash is a hash of component identifier (e.g., URI)+tags+parent path hashes (if any). The path hash is specifically designed to avoid collision with another data path's path hash. To that end, a hashing algorithm is utilized which has a very low chance of collision. In another embodiment, whole paths may be transported literally and no hashing is performed (thereby avoiding the potential for collision). This embodiment may further involve a compression process.

It is appreciated that, in another embodiment, additional or other pieces of data may be tracked for each step 150. Such additional data may be stored in the metadata store separate from but associated to the data path.

In one embodiment, only data generation and data transformation actions are represented via the creation of new steps 150. For each step 150, different information may be tracked in the tags. For example, for a particular health monitoring device (e.g., wrist worn band), a serial number may be included as a tag. In the example of specific transformations or processes, (e.g., the Willpower™ function of Assignee hereof), the tag may include the function name and version. In the instance where data is pulled or pushed from an application running on a computerized device (e.g., UA Record belonging to Assignee hereof), the user identifier and/or operating system on the device may be used as tags. In another alternative, any of the foregoing may, rather than remain in the data path as a tag, but stored separately (as discussed elsewhere herein). To further this logic, it is appreciated any kind of market or user segmentation information may be used as a tag (such as if it changing should constitute a new data path), or stored in the metadata store (in the instance the information comprises something useful for analytics).

In one specific embodiment, it is advantageous to track a function version number as part of the identity of a function. Specifically, this becomes advantageous when a formula on the transformation apparatus 106 is updated. In this instance, the topologies on the transformation apparatus 106 may be updated immediately, but the formula at the client-side applications is not updated. Rather, the system continues to run topologies on the transformation apparatus 106 using both versions of the formula in parallel, and the results are provided to the user device which match the formula it still has. When the user updates the client-side application, the new version is implemented seamlessly.

In a further embodiment, in order to express data paths in an expanded way, an alternative format may be utilized. Accordingly, the schema used to express data paths as documents is versioned; i.e., a version number is utilized. In this manner, any system consuming the structure of a data path can know if it has the requisite capability to process the structure or not. The number of instances where a system can access a schema it is incapable of using may be limited. In addition, conversion from one schema version to any other inside the data path service 104 may be utilized to enable calling clients to specify the schema they want to receive. Accordingly, downstream clients (including any mobile data path libraries) would only have to deal in one schema format.

In order to enable this specific embodiment, the data path service 104 is aware of the most recent schema format, the previous formats, and is able to access and use one or more separate converter processes. Hence, when a client asks for e.g., version 1, the service 104 pulls the document out of the database 112. Assume the document is determined to be version 3, the service 104 simply sends the document to a v3-to-v1 converter, and responds to the client with whatever comes out of the converter. Similar logic applies when the service 104 receives version 2, i.e., it sends it to the v2-to-v3 converter before doing anything else with it (like indexing and storing it). Similarly, when it is determined that a data path has persisted with an old schema, the service 104 may pull it, convert to the most recent version, and re-store it with the new version to simplify later access, gradually upgrading all the data paths that are actually in use.

Referring back to FIG. 1, the health parameter service 105 comprises one or more computerized devices operable to receive health parameter data from e.g., the user devices 102, the data path service 104, and/or the transformation apparatus 106 for analysis and storage at the storage apparatus 113 associated therewith. The specific functions of exemplary health parameter service 105 will be discussed in greater detail below.

Also illustrated in FIG. 1 as indicated by item (1), data is collected at a first user device 102 and provided, via the network 108, to the path service 104 and/or one or more of a plurality of transformation apparatus 106. More specifically, in one embodiment, the user device 102 provides collected data to the path service 104 for metadata generation and/or storage (as discussed below). In another alternative, metadata is generated at the user device 102 itself and therefore the data may be passed directly to one or more transformation apparatus 106. In such an instance, the data may be simultaneously provided to the path service 104 for storage thereof and the user device 102 may further comprise a metadata generation application (such as metadata generation application 110).

Next at item (2), the path service 104 generates a metadata tag for the data which includes a description of the action performed (e.g., data generation), the device which performed the action (e.g., user device 102), and an identifier of the user to which the data relates. The data is stored at the data storage entity 112 of the path service 104 and further provided to the transformation apparatus 106 (item (3)). As noted above, the transformation apparatus 106 comprises any entity configured to manipulate or transform the data including e.g., other user devices. In one embodiment, the transformation apparatus 106 transforms the data, then provides the transformed data back to the path service 104 for metadata generation and/or storage (item (4)). In another alternative, the metadata is generated at the transformation apparatus 106 itself. In such an instances, the data may be simultaneously provided to the path service 104 for storage thereof and the transformation apparatus 106 may further comprise a metadata generation application (such as metadata generation application 110).

The transformed data is then output (item (5)) from the path service 104 to any other device to utilize the data. Specifically, the data may be output to other transformation apparatus 106 (such as for further transformations), other user devices 102 (such as for display), etc., as discussed in further detail below.

Exemplary methods of data tracking within a network of devices are discussed in further detail below.

### Methodology

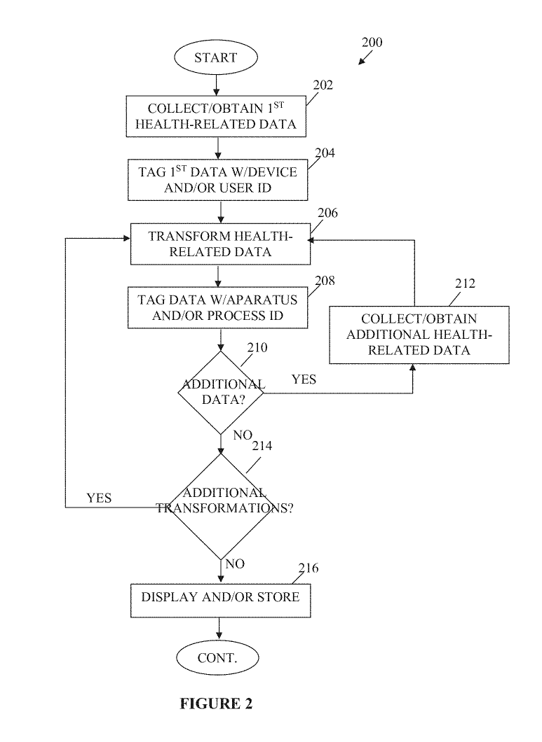

Referring now to FIG. 2, an exemplary method 200 for tracking data within a network of devices is given. As shown, per step 202, first health related data is obtained or collected. In one embodiment, the health related data is collected at a path service 104 from one or more user devices 102 which are configured to sense, measure, generate or otherwise obtain the data. For example, a user device 102 may comprise a sensor configured to sense heart beat data, an accelerometer configured to generate accelerometry data, and/or other devices configured to obtain health data relating to the user.

Next at step 204, a first metadata tag is generated which corresponds to the collected data. In one embodiment, the metadata comprises information which identifies the device from which the data originated (e.g., the user device 102) and/or a user to whom the data is associated. The metadata tag may be attached to the data itself, in one embodiment, or alternatively the data may comprise a pointer which indicates a position within storage, such as the data storage entity 112, at which the metadata may be located.

Once collected and tagged, the health related data is transformed via a first transformation process (step 206). Assume, in one specific example, that the collected data comprises accelerometry data collected by a wrist worn device as the user runs. In such example, the data is collected from the wrist worn device and tagged via a metadata generation application 110; then it is provided to an application at a second user device 102 configured to transform the data e.g., from accelerometry data to a step count and/or distance travelled.

The metadata tag created at step 204 is updated to include metadata which identifies the transformation apparatus 106 and the transformation process performed (i.e., process identifier or process ID) at step 208. Continuing the example above, the metadata tag created to describe the collected data is updated to include a reference to the step count process and/or distance travelled process applied thereto by the second user device 102.

It is next determined whether additional data should be collected (step 210). In the instance that additional data is to be collected, per step 212, the additional data is collected and/or obtained. Instances where additional data may be required include e.g., instances where data is being collected continuously and it is provided to e.g., the path service 104 periodically. This occurs e.g., when determining a user's total step count for an entire day. Other instances where additional data may be required include e.g., instances where second data is needed to create a third data type. For example, a determination of distance travelled may be based on accelerometry data from a first device and map or position data from a second device (alternatively, all of the data may originate from a single device).

When it is determined that no further data is needed at step 214 it is further determined whether additional transformations are to be performed to the data. Where additional transformations are to occur, the process repeats at step 206. In one example, multiple transformations may occur to arrive at a measure of workout intensity. That is, heart rate data may be transformed at a first transformation step to arrive at zone data; i.e., data that indicates which times during a workout a user was in each of a green, yellow and red heart rate zone. The zoned data may then be transformed again to determine a percent of the entire workout time which the user spent in the yellow zone and a percent of the entire workout time which the user spent in the red zone, then use these percentages to derive an intensity factor (such as a number from 1-10).

When it is determined that no further transformations are needed, then per step 216, the data is displayed and/or stored. It is appreciated that data once displayed and/or stored may be later accessed for further transformations including transformations which incorporate other data (as discussed above).

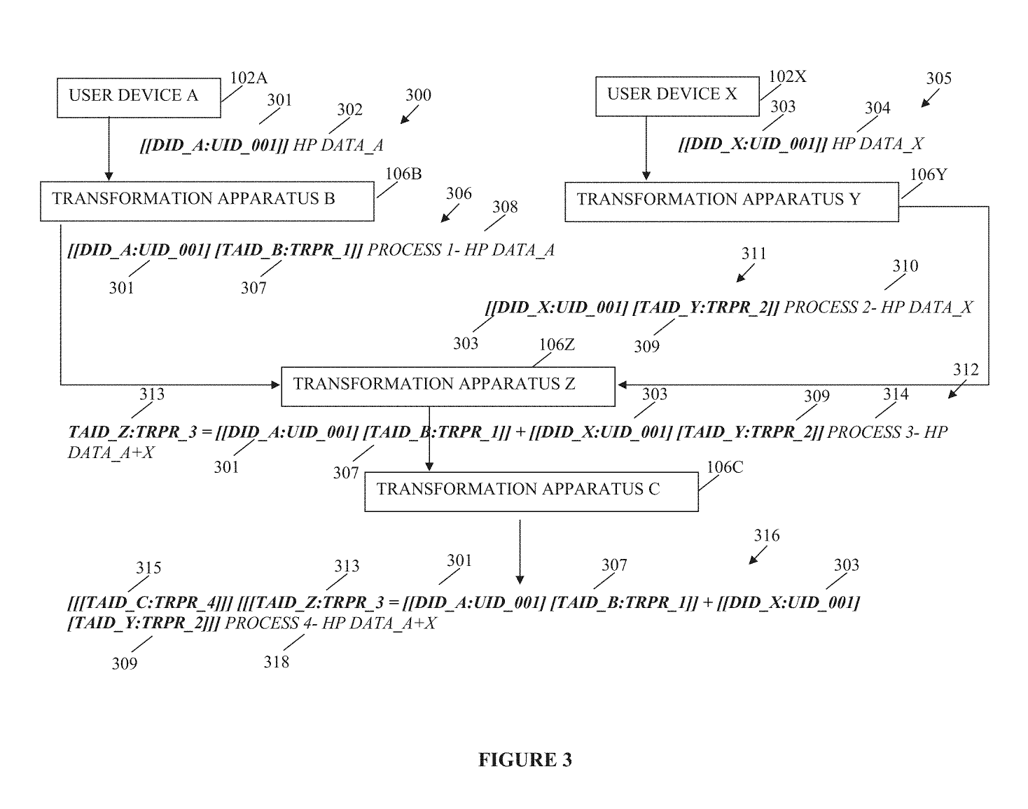

As noted elsewhere herein, it is appreciated that the aforementioned metadata tag generation steps may occur at the device which generates, collects, obtains, and/or transforms the data. Moreover, the metadata tags may be applied or attached to the data itself, or alternatively the data may be associated to a particular location in storage 112 at which the metadata tag is kept and updated. It is further noted that when two data elements or records are combined in a transformation step, a third new data record is created which may include each of the metadata tags of the data which was combined to create it. An example is demonstrated below with regard to FIG. 3.

### Exemplary Data Flow

FIG. 3 demonstrates one exemplary embodiment of a data flow which illustrates typical data tracking within a network of devices. As shown, user device A 102A generates a health parameter data record 300 which consists of a metadata tag 301 and the health parameter data itself 302. Specifically, the health parameter data record 300 includes a device identifier (DID) to device A, as DID_A and a user identifier (UID) to user 001, as UID_001. The health parameter data A 302 in this instance is denoted as HP DATA_A.

Also illustrated in FIG. 3, the health parameter data record 300 is next provided to transformation apparatus B 106B, which performs process 1 on the data 302. The resultant data record 306 is provided with an updated metadata tag. The updated metadata includes the original metadata 301 (comprising DID_A and UID_001 in this example) as well as a new metadata tag 307 which includes a transformation apparatus identifier (TAID) for transformation apparatus B, as TAID_B and a transformation process identifier (TRPR) for process 1, as TRPR_1. Each step of the generation of the data tag is separated from the other steps via the use of brackets. The transformed health parameter data 308 in this instance is denoted as PROCESS 1-HP DATA_A.

As also illustrated in FIG. 3, health parameter data X 304 is generated at user device x 102X. The data record 305 which is created is given a metadata tag indicating device identifier for user device x, DID_X, and user identifier for user 001, UID_0011. The health parameter data X 304 in this instance is denoted as HP DATA_X.

Next, the data record 305 is provided to transformation apparatus Y 106Y, where transformation process 2 is performed. The resultant data record 311 is provided with an updated metadata tag. The updated metadata includes the original metadata 303 (comprising DID_X and UID_001 in this example) as well as a new metadata tag 309 which includes a transformation apparatus identifier (TAID) for transformation apparatus Y, as TAID_Y and a transformation process identifier (TRPR) for process 2, as TRPR_2. Each step of the generation of the data tag is separated from the other steps via the use of brackets. The transformed health parameter data 310 in this instance is denoted as PROCESS 2-HP DATA_X.

As shown in FIG. 3, data records 306 and 311 are both provided to transformation apparatus Z for further processing. In this instance, the two data records are entered into a process which combines the records (i.e., process 3); however it is appreciated that any number of transformational processes may be applied, the foregoing being merely exemplary. The resultant data record 312 is provided with an updated metadata tag. The updated metadata includes the original metadata tags of: (i) the data that originated at device A 102A and was processed at transformation apparatus B 106B (i.e., [[DID_A:UID_001] [TAID_B:TRPR_1]], and (ii) the data that originated at device X 102X and was processed at transformation apparatus Y 106Y (i.e., [[DID_X:UID_001] [TAID_Y:TRPR_2]]), as well as a new metadata tag 313 which includes a transformation apparatus identifier (TAID) for transformation apparatus Z, as TAID_Z and a transformation process identifier (TRPR) for process 3, as TRPR_3. The new metadata tag further includes operators which indicate relationships between the previously created metadata tags, in this case, the new tag 313 is shown as being equal to “=” the combination of metadata tag 301/307 and metadata tag 303/309 via the use of a plus “+” sign. The transformed health parameter data 314 in this instance is denoted as PROCESS 3-HP DATA_A+X.

A final transformation occurs where the data record 312 is provided to transformation apparatus C, and process 4 is performed. The resultant data record 316 is provided with an updated metadata tag. The updated metadata includes the previous metadata (including metadata 313, 301, 307, 303, and 309 as well as a new metadata tag 315 which includes a transformation apparatus identifier (TAID) for transformation apparatus C, as TAID_C and a transformation process identifier (TRPR) for process 4, as TRPR_4. Each step of the generation of the data tag is separated from the other steps via the use of brackets. The transformed health parameter data 318 in this instance is denoted as PROCESS 4-HP DATA_A+X.

As is demonstrated by the above, any number of transformation steps may be performed on data, at each instance a new metadata tag is created which adds on to the pre-existing metadata tag in a way that demonstrates the relationship between the data which was transformed to create the current data as well as the devices and users to which it is associated. In this manner, each piece of data will comprise (or be associated to) metadata which describes exactly where it originated as well as every processing step which was performed to arrive at the current data record.

It is further appreciated that when the source of data as well as each device and transformation step performed on data are known, certain data may be prioritized over other data as being more trustworthy or of higher quality and/or reliability. That is to say, a particular transformation apparatus may review individual data records to determine whether one or the other should be relied upon as being of higher fidelity. In this manner, the subsequent transformation processes that are performed will have increased accuracy.

### Specific Use Cases

The herein described data paths may be utilized for analysis of various information relating to health parameter data collected from one or more athletes. Provided herein are various ones of such uses cases; i.e., instances where an operator at the path service 104 and/or a user at a mobile or user device 102 may analyze data by accessing one or more data paths. It is appreciated that the exemplary use cases discussed herein are merely exemplary of the concepts herein and are not intended as an exhaustive list of uses; other uses may become apparent given the discussion elsewhere herein.

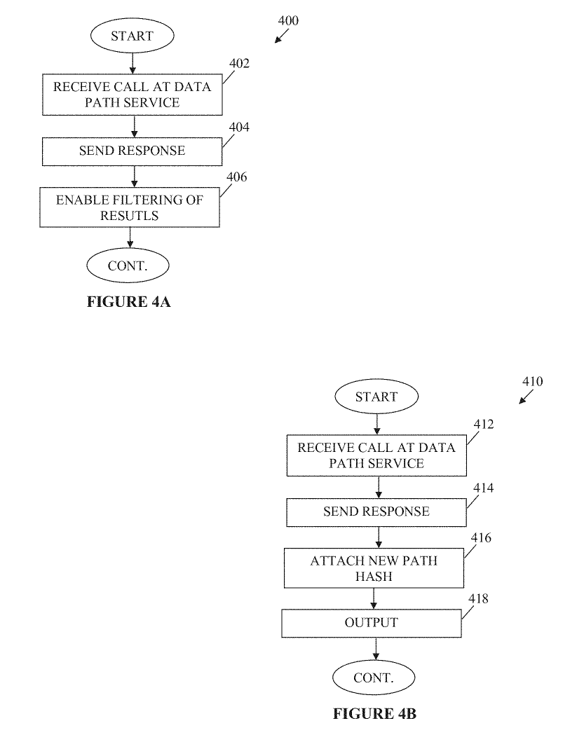

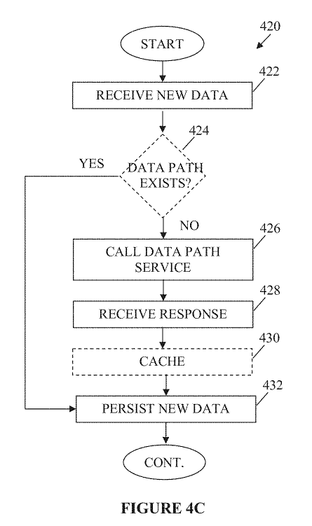

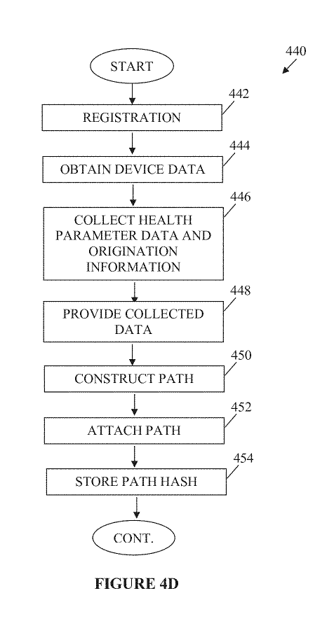

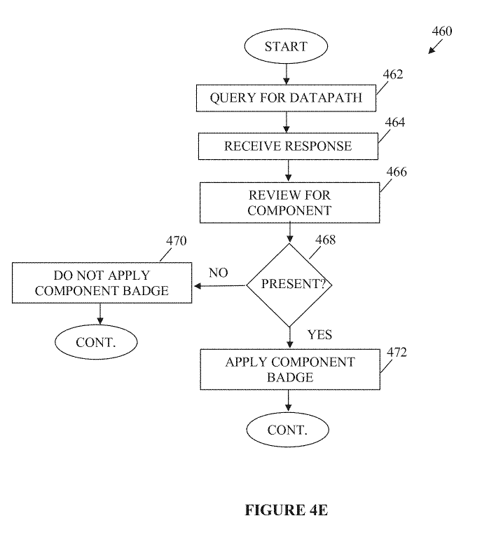

In the specific embodiment of FIG. 4A, a health parameter service 105 (in communication with a user device 102) is utilizing data paths to determine which of a specific user's health parameters came from a specific sensor device; in this instance, the Gemini 2 product of Assignee hereof having a foot pod (i.e., a sensor device that is placed in or on a user's shoe or shoes). Accordingly, FIG. 4A illustrates an exemplary method 400 for obtaining data relating to all health parameters recorded using a specific health monitoring device.

As shown, per step 402, the health parameter service 105 calls the data path service. It is appreciated that in the present example, the health parameter service 105 has access to the shoe's component (com.ua.gemini2) through e.g., a component management service. Moreover, the health parameter service 105 has access to the user's identification number, in this instance 12345. Accordingly, the health parameter service 105 specifically asks the data path service for all health parameter identifiers or tags that contain “com.ua.gemini2”.

Next at step 404, the data path service responds with a (potentially large) list of path hashes. In one exemplary embodiment, certain business rules implemented at the path service 104 indicate that any responses returned are provided in order by most to least recent and that response only a certain number of instances are to be provided (e.g., 20 workouts). In one embodiment, the health parameter service 105 stores this health parameter data at the storage device 113 in a relational database with some appropriate indices to reference path hashes and user identifier.

Next at step 406, the health parameter service 105 filters the user's health parameters provided in the list. In one specific embodiment, the filter may comprise the following:

SELECT

*FROM workouts WHERE user_1id=“12345” AND path_hash IN (23489fb781fd, . . . ) ORDER BY created_at DESC LIMIT 2θ. Eqn. 1

The results, once filtered, provide only those health parameters which were logged using the Gemini 2 training shoes.

Referring now to FIG. 4B, a logical flow diagram illustrating an exemplary method 410 for appending data to an existing data path is given. According to this embodiment, a data series service (i.e., one or more transformation apparatus 106 configured to perform one or more transformation steps on data) is running some data through a topology (i.e., a series of steps). In this example, each input into the topology has its own path hash before it is pulled in for modification.

The method 410 of FIG. 4B is applied for each function in the topology. It is also noted that a path hash exists for every piece of data that is pulled into the topology; additionally, a component tag identifies each function in the topology. As shown, per step 412, the data series service (at the transformation apparatus 106) calls the data path service (at the path server 104) with the path hashes of each input data series to the function as well as the component that identifies the function.

The data path service then responds at step 414 with a path hash. If there was more than one input data series, this new data path includes a merge step as the function. However, in one embodiment, that fact is opaque to the data series service. The provided path hash may be entirely new or not (a fact which may also be opaque to the data series service).

Next, at step 416, the new path hash is attached to each output data series and at step 418, the newly marked data is output to the next function or to topology output.

In the specific embodiment of FIG. 4C, the health parameter service 105 receives a new health parameter (such as from a client device 102) and intends to persist it; therefore a path hash is needed. Accordingly, FIG. 4C provides an exemplary method 420 for obtaining a data path identifier.

As shown, per step 422, the health parameter service 105 receives new health parameter data. According to one embodiment, the client device includes library code from which a data path structure may be put together including all the relevant components and how they relate to describe how the data got off the device. Next, the health parameter service 105 optionally checks a cache to see whether the data path structure described in the request maps to a previously and/or recently encountered path hash (step 424). When the data path already exists, the method 420 continues to step 432 wherein the data is persisted with the path hash included.

When the data path does not already exist, then per step 426, the health parameter service 105 calls the data path service using the entire data path structure described in the request. The data path service responds with a path hash at step 428. This path hash may be entirely new or not, but this fact is opaque to the health parameter service 105.

At step 430, the health parameter service 105 optionally caches this path hash as referring to the data path structure it received; and at step 432, the health parameter service 105 persists the new health parameter with the path hash included. In one embodiment this includes storage thereof at the data storage apparatus 113.

Referring now to FIG. 4D, another use case is given. According to this use case, a health monitoring application at the user device has recorded new health-related data that needs to be synchronized to network storage 112. Therefore, FIG. 4D provides an exemplary method 440 for sending new data to be persisted.

Per step 442, on start-up, the health monitoring application registers itself with the server library, specifying its component (e.g., com.ua.run) and version. Data relating to the user device 102 is collected at step 444 including e.g., hardware type, operating system type, and version, etc. Additionally, at step 444, the device library may inspect the device to tell what component it is and any other data it needs from the device (like firmware version, etc.).

At step 446, a new health parameter is created and data relating thereto is collected, as well as the device object that any data originates from (whether it is a foot pod in a shoe in communication with the application, or an accelerometer inside the phone). The data and metadata are kept together. It may do this for all health parameter data collected throughout the duration of a workout as a whole, as well.

The collected data is then sent to the data server 112 for storage thereat (at step 448). In one embodiment, the health monitoring application informs the server library to send a health parameter to the servers. The server library in turn asks the data path library to construct a path for each piece of data attached to the health parameter. Accordingly, per step 450, the data path library assembles the correct path structure associated to the device, application, etc. and returns it.

Next, at step 452, the server library attaches the data path structures to the health parameter data and sends it to the server. The server processes the data and responds; the response contains a path hash in place of the sequences that were originally sent. Hence at step 454, the health monitoring application caches the path hashes next to the data it originally stored for the health parameter for later reference.

Referring now to FIG. 4E, a logical flow diagram illustrating an exemplary method for determining whether a component is included in a data path is given. This use case is particularly useful in the instance that the health-monitoring application would like to place a badge on certain data as being associated to a particular device. For example, Assignee hereof may display a badge indicating certain health parameters as “Record Equipped” when they were obtained via any one of a plurality of specially designated devices. To do so, per step 462, the health-monitoring application running at the client device 102 first asks the path server 104 for the structure of the data path associated with each health parameter.

In response, step 464, the full structure of the data path is provided. The health monitoring application may then query the data path library to review the list for any components which are designated as being of interest as occurring within the data path structure (step 466). The health monitoring application may, in one embodiment, be preloaded with a list of the components for all devices that count as “Record Equipped” (e.g., com.ua.gemini2, com.ua.healthbox-band, com.ua.healthbox-scale, com.ua.healthbox-hrm), in this example.

The data path library traverses the data path structure of each of the returned paths looking for the components (step 468) and returns an answer. According to this example, a badge is not applied (step 470) when it is determined that a particular path does not include a component from the list. When it is determined that the component is present in a path, a badge is applied (step 472) to the data associated with that path.

In another embodiment, the foregoing method may be pre-performed on the server and included in the payload to the device. In other words, the server (e.g., data path service 104) may be configured to automatically (i.e., without prompting from the client-side health monitoring application) review returned records from any query for those which contain a component on the pre-determined list. When query results are provided to the client-side health monitoring application, they include data relating to whether particular ones of the records should or may be marked in some way (e.g., whether a badge should or may be applied).

### Additional Embodiments

The herein described data path service 104 may be utilized in various user-facing use cases, internal and real-time use cases (which enable the user-facing uses cases), as well as internal asynchronous use cases (for analytics and/or debugging), as discussed herein.

The user-facing use cases are configured to provide answers to questions which a user may have relating to the collected health parameter data, including for example: which device recorded this data; during which workouts did I use my heart rate monitoring device; does this workout include data from a pre-loaded list of devices (e.g., the so-called “Record Equipped” devices discussed previously); where did this stride length information come from; and when was the last time I stored data from my phone; etc. Many of these questions are answered using data from the data path service 104 in conjunction with data from other services (as discussed herein).

In the example to determine which device recorded particular data, the client traverses the structure of the data path looking for components (by searching device identifiers in each data path) that the client's business rules define as meaningful devices. In one embodiment, the foregoing query is submitted at a user interface at the user device 102, and submitted for performance by the path service 104.

In the example to determine which workouts a particular heart rate monitoring device was used, the client obtains a list of path hashes from the data path service 104 that includes the heart rate monitor's component identifier, which is then used to filter the user's workouts. In a further embodiment, a set of complex, predefined filters may be used to enable a user to switch between which provide additional functionality. Specifically, a product owner decides on a partial sequence of steps that would describe the data paths that match the filter (for example, it has a so-called “Record Equipped” device downstream of a short list of specific health monitoring applications e.g., UA Record, UA Run, etc. and does not include some specific function). In one variant, a small service is stood up that listens to data path creation events and as each one comes in, it compares the structure to the partial sequence and if it matches, it keeps the path hash in a list. This list may be dynamically synchronized to any number of places (including phones) that could then use the list to filter workouts as above.

In the example to determine whether a workout includes data from a pre-loaded list of devices (e.g., the so-called “Record Equipped” devices discussed previously) the client traverses the structure of the data path looking for components that the client's business rules define as signaling “Record Equipped”.

In the example to determine where the stride length information came from, the client traverses the structure of the data path looking for components that the client's business rules define as meaningful-to-convey-to-the-user in order to explain the stride length calculation. In one embodiment, stride length may be derived from step and location data (which came from other sources).

In the example to determine the last time data from the phone was stored, the client obtains a list of path hashes from the data path service that includes the phone's component. The list is then used to search for the most-recent step data stored with one of those hashes.

The internal real-time use cases are configured to provide answers to questions which underpin the user-asked questions discussed above. These questions represent the behind-the-scenes determinations that are made in order to provide meaningful responses to user queries, and include, for example: which data paths include a particular component; what is the path hash for a particular data path; and what is the structure of the data path for a particular path hash; etc. Many of these answers are supplied directly by the data path service 104 to enable downstream clients to deliver user-facing cases like the above. Thus, all these cases are satisfied in some reasonably small response time.

In the example to determine which data paths include a particular component, a component (e.g. com.ua.record) is provided within a query, and in response, a list of path hashes is received. The list is used to enable user-facing cases like “During which workouts did I use my heart rate monitor?” and “When was the last time I stored step data from my phone?”, as discussed above. With the list, the requesting client can also determine which of those path hashes apply to the user in question within the appropriate related data.

In the example to determine what the path hash is for a particular data path, the health parameter service 105, for example, may have a data path that describes how the data arrived at the health parameter service 105 and need to exchange that for a path hash to actually store. This would also including taking a path hash and adding a new step to the end of it. This is important for persisting data that will be tracked. In another specific example, a particular transformation apparatus 106 is configured to take step and location data and derive stride length therefrom. In doing so, the transformation apparatus 106 has access to the data path of the step data and the data path of the location data, but needs to append itself to the end of those before the stride length data is persisted. Therefore, the foregoing method is employed.

Regarding the structure of the data path for a particular path hash, given a path hash, client systems may need to know about the structure that it refers to. This enables user-facing cases like: “Which device recorded this step data?”, “Does this workout include data from a Record Equipped device?” and “Where did you get my stride length information from?”. Since the schema for expressing this structure will be versioned, clients will need to specify the path hash and the schema version they want back. In one embodiment, shared libraries for traversing this structure may additionally be utilized.

The internal asynchronous use cases are configured to provide answers to operator questions relating to analytics and/or debugging, including for example: how many workouts, across users, have received data from a particular user device; what percentage of workouts recorded in the last month came from a particular health monitoring application; which devices, across the whole of users of a particular health monitoring application, were used to record any kind of data this week; which data points were transformed through the location-and-steps-to-stride-length service when it had a bug; and which data points were transformed through the location-and-steps-to-stride-length mobile library when it had a bug; etc. These are use cases where an answer may be generated more slowly (i.e., not immediately). It is further noted that many of these questions may be answered by other systems that asynchronously feed off of events emitted by the data path service 104.

The example relating to how to determine how many workouts, across users, have data from a particular user device, may be answered very similarly to “During which workouts did I use my heart rate monitor?” (discussed above) but does not include any filtering by user identifier. Given the practical limits of querying that much data from the health parameter service 105, in one embodiment, that query may be run against a reporting system.

Since version data is part of the metadata store, getting the answer to what percentage of workouts recorded in the last month came from a particular health monitoring application is not simple. First, the list of all data paths that include the component for the particular health monitoring application is obtained. Then all the workouts with those paths are pulled from the health parameter store or database 113. Then one would look up each data path's metadata and compare the workout time to the times in the metadata store 112. In another embodiment, a reporting system is provided which listens to various events from these two services and calculates version break-downs on a rolling basis.

In the example to determine which devices, across the whole of users of a particular health monitoring application, were used to record any kind of data this week, in one embodiment first, all the logical data records that were created this week (e.g. workouts, data series, meals, training plans, etc.) are pulled (based on a date/time stamp associated thereto) into a list of all the associated path hashes. In one variant, this step involves the use of an asynchronous reporting store which listens to all incoming events and stores only the path hash and a timestamp for each. The unique list of path hashes, is individually queried to get the structure of each path which are then traversed looking for relevant components that equate to whatever the business definition of “device” is for this metric.

In order to determine which data points were transformed through the location-and-steps-to-stride-length service when it had a bug, it must be determined which timeframe the bug affected. In one example, a logic error in the data transformation may be implemented in code. If the transformation were run on certain data points in a time interval, the system is able to use the data path to find the points and retransform them to remove the logic error.

In order to determine which data points were transformed through the location-and-steps-to-stride-length mobile library when it had a bug, it must be determined when the bug was live. To do so, all the path hashes that include the application component in question are determined, then the version of the buggy component is identified. A review of the metadata store for all path hashes that used that version of the component identifies trouble spots. Then, (background) notifications are pushed to those user's phones to see if they have stride length data in the timeframe that needs fixing. In one embodiment, rather than fix the problem on the client, the data is simply replaced with fixed data calculated on the server.

### Advanced Data Storage Solutions

As noted above, various different types of health parameter monitoring devices are entering the market and users often utilize more than one device simultaneously or throughout the course of their day. Current storage solutions involve storing data-over-time (timeline data) in a number of different places and formats. However, such storage makes comparison and/or deduplication of the data difficult if not impossible.

In one embodiment, the foregoing issues are resolved via an advanced data storage solution wherein timeline data is stored in one continuous stream for each data type or data path. In a further variant, controls are provided which enable developers to do aggregation and analysis of the stored continuous stream timeline data. The continuous stream timeline data may be stored at e.g., the health parameter storage apparatus 113 and/or the data storage apparatus 112. In another embodiment, some or all of the data which is described elsewhere herein as being stored at e.g., health parameter storage 113 and/or data storage 112 is stored as a single data storage location as the aforementioned timeline data. In this manner, health parameter data (e.g., workouts, sleep, weight, nutrition, etc.) may be accessed and shared across all connected devices and platforms.

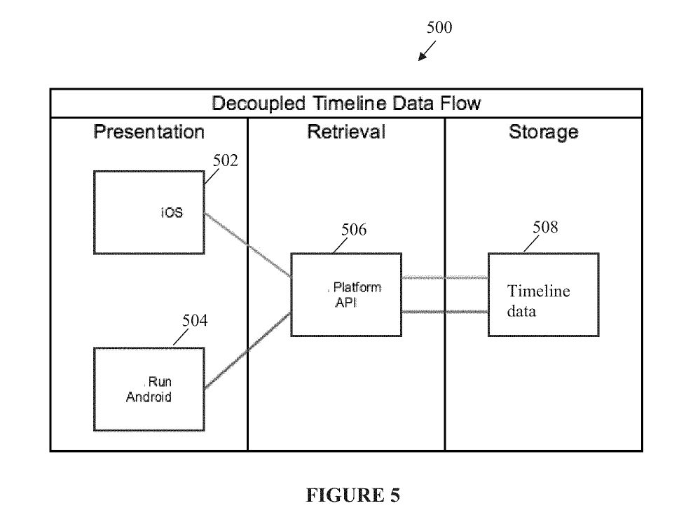

In one specific variant, the shared portion of the system is moved to storage of raw data and controls for aggregation. Accordingly, each platform or application is decoupled; thereby reducing friction between them and increasing development speed and product agility. This decoupling is illustrated in FIG. 5. As shown in the exemplary data flow 500, two different mobile applications running on two different device platforms (Apple® iOS and Android®) are requesting different roll-ups of the same continuous stream of timeline data using the improved storage solution. As shown, a single data store 508 is accessed via the platform API 506 (e.g., of a server-side application such as a health parameter application) to provide the data in this example to the Apple® iOS device 502 (and/or a client application running thereon) and the Android® device 504 (and/or a client application running thereon).

In one exemplary implementation, the foregoing data flow 500 may be utilized to present portions of the continuous stream timeline data to a user at the user device 502, 504 for analysis, processing, etc. thereat. In another exemplary implementation, the foregoing data flow 500 may additionally be utilized to provide data to be added to a continuous stream data timeline from and relating to the devices 502, 504 to the timeline data storage 508. It is appreciated that in each of the foregoing embodiments, the data may be uniquely associated to a user, device, etc. such as via the data path methods described above.

In another embodiment, the continuous stream timeline data may be accessed across any number of network and client applications, including e.g., the aforementioned health parameter monitoring applications.

As illustrated, the centralized storage of continuous stream timeline data improves the uniformity and accuracy of timeline data gathered from different sources. Additionally, this enhanced data storage solution increases product agility, and enhances an ability to extend and improve health monitoring applications including via analysis and presentation to users.

It will be appreciated that variants of the above-described and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the following claims.

The herein described applications (including e.g., the metadata generating application 110) improve the functioning of the user device 102, transformation apparatus 106, health parameter service 105, and/or path service 104, respectively or in combination by enabling it/them to track health parameter data within a network of devices. Furthermore, devices that are able to trace data from its generation through multiple transformations can operate more efficiently to analyze such data, determine a data origin, and ensure the most reliable data is utilized for future transformations. By tracking more information about the path data has taken, such tracking is made easier (and, thus, faster); adding features also provides agility to product owners in what pieces of data (i.e., from what source) they want to key such features off of. Moreover, certain users might further utilize the herein disclosed methods and apparatus in order to analyze from where their data is coming, and flowing through (especially as the number of devices a user has increases). Further analytics may enable grouping of users and user activity based on the devices they are using; rather than merely by the requests they make to the API.

It will be appreciated that the various ones of the foregoing aspects of the present disclosure, or any parts or functions thereof, may be implemented using hardware, software, firmware, tangible, and non-transitory computer readable or computer usable storage media having instructions stored thereon, or a combination thereof, and may be implemented in one or more computer systems.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A method of tracing health-related data within a network of devices, said method comprising:
receiving, at a network apparatus, said at least one health-related data record generated at a health monitoring device;
generating first metadata comprising at least information identifying said health-monitoring device;
providing said at least one health-related data record to an apparatus configured to perform a transformational operation thereon to generate at least one transformed data record; and
generating second metadata comprising at least information identifying said apparatus and said transformational operation which was performed;
wherein said first and second metadata are stored as a single metadata file relating to said at least one transformed data record.

2. The method of claim 1, further comprising:
receiving, at said network apparatus, at least one second health-related data record collected at a second health monitoring device;
generating third metadata comprising at least information identifying said second health-monitoring device and an apparatus from which said at least one second health-related data record was collected; and
providing said at least one second health-related data record to said apparatus configured to perform said at least one transformational operation prior to said performance of said transformational operation.

3. The method of claim 2, further comprising segmenting said first and second health-related data records into a plurality of time segments; and
wherein said apparatus configured to perform said at least one transformational operation is further configured to evaluate said second and third metadata to determine which of said first health-related data record or said second health-related data record comprises a more reliable data record for each of said plurality of time segments and perform said transformational operation thereon.

4. The method of claim 2, further comprising:
determining, based on said third metadata, that said apparatus from which said data was collected by said second health monitoring device comprises said first health monitoring device; and
based on said act of determining, electing to perform said transformational operation on said first health-related data record.

5. The method of claim 1, further comprising:
providing said at least one transformed data record to a second apparatus configured to perform a second transformational operation thereon to generate at least one second transformed data record; and
generating third metadata comprising at least information identifying said second apparatus and said second transformational operation which was performed.

6. The method of claim 5, wherein said third metadata is stored with said first and said second metadata as said single metadata file relating to said at least one second transformed data record.

7. The method of claim 1, wherein said act of providing said at least one health-related data record comprises providing a data package including said at least one health-related data record and said first and second metadata.

8. A network apparatus configured to enable tracing of at least one health-related data record representative of at least one health-related parameter of at least one user within a network of devices, said network apparatus comprising:
an interface configured to enable communication between said network apparatus a health monitoring apparatus, and at least one transformational apparatus;
a storage apparatus; and
a processor configured to execute at least one computer program thereon, said computer program comprising a plurality of instructions which are configured to, when executed, cause said network apparatus to:
receive at least one health-related data record generated at a health monitoring device;
generate first metadata comprising at least information identifying said health-monitoring device;
provide said at least one health-related data record to said transformational apparatus configured to perform a transformational operation thereon to generate at least one transformed data record;
generate second metadata comprising at least information identifying said transformational apparatus and said transformational operation which was performed; and
store said first and second metadata as a single metadata file relating to said at least one transformed data record.

9. The network apparatus of claim 8,
wherein said at least one health-related data record comprises heart rate data collected during a workout session; and
wherein said plurality of instructions are further configured to, when executed, cause said network apparatus to:
receive at least one second heart rate data record collected at a second health monitoring device during said workout session; and
generate third metadata comprising at least information identifying said second health-monitoring device and an apparatus from which said at least one second heart rate data record was collected, said transformational apparatus being further configured to determine, based on said second and said third metadata, which of said first health-related data record or said second health-related data record comprises a more reliable data record and perform said transformational operation thereon.

10. The network apparatus of claim 9, wherein said at least one transformational operation comprises a process which employs a combination of one or more portions of said at least one first health-related data record which are determined to be more reliable than corresponding portions of said at least one second health-related data record, and one or more portions of said at least one second health-related data record which are determined to be more reliable than corresponding portions of said at least one first health-related data record, to generate said at least one second transformed data record.

11. The network apparatus of claim 8, wherein said plurality of instructions are further configured to, when executed, cause said network apparatus to:
provide said at least one transformed data record to a second apparatus configured to perform a second transformational operation thereon to generate at least one second transformed data record;
generate third metadata comprising at least information identifying said second apparatus and said second transformational operation which was performed.

12. The network apparatus of claim 11, wherein said third metadata is stored with said first and said second metadata as said single metadata file relating to said at least one second transformed data record.

13. The network apparatus of claim 8, wherein said act of providing said at least one health-related data record comprises providing a data package including said at least one health-related data record and said first and second metadata.

14. A non-transient computer readable medium comprising a plurality of instructions which are configured to, when executed by a processor:
generate first metadata comprising at least information identifying a first health-monitoring device from which at least one first health-related data record was received;
generate second metadata comprising at least information identifying:
(i) a transformational apparatus which applied a transformational operation on said at least one health-related data record; and
(ii) said transformational operation which was performed; and
store said first and second metadata as a single metadata file relating to said at least one health-related data record.

15. The computer readable medium of claim 14, wherein said plurality of instructions are further configured to, when executed:
generate third metadata comprising at least information identifying a second health-monitoring device at which at least one second health-related data record was collected and an apparatus from which it was collected

16. The computer readable medium of claim 15, wherein said transformational operation is performed on said at least one second health-related data record simultaneous to said performance thereof on said at least one first health-related data record.

17. The computer readable medium of claim 15, wherein said transformational apparatus is further configured to examine said second and third metadata to determine a reliability of said health-related data record based on an identity of said first and said second health-monitoring device and utilize said reliability in determining on which data said transformational operation is to be performed.

18. The computer readable medium of claim 17, wherein:
said first health-monitoring device comprises a heart rate monitor;
said at least one first health-related data record comprises a measure of heart rate during a first time period;
said second health-monitoring device comprises a wrist worn activity tracker;
said at least one second health-related data record comprises a measure of heart rate during said first time period;
said apparatus from which said at least one second health-related data record is collected during said first time period comprises said heart rate monitor; and
said transformational apparatus is further configured to, based on a determination from said metadata that said at least one first and said at least one second health-related data record are collected from said heart rate monitor, utilize in said transformational operation only said at least one first health-related data record during said first time period.

19. The computer readable medium of claim 14, wherein said plurality of instructions are further configured to, when executed:
generate third metadata comprising at least information identifying a second apparatus configured to perform a second transformational operation on said at least one transformed data record to generate said at least one second transformed data record; and
store said third metadata with said first and said second metadata as said single metadata file relating to said at least one second transformed data record.

20. The computer readable medium of claim 14, wherein said transformational apparatus is provided with a data package including said at least one health-related data record and said first and second metadata.
